(19) United States
(12) Patent Application Publication
(10) Pub. No.: US 2026/0230997 A1
(43) Pub. Date: Aug. 6, 2026

(54) METHODS AND APPARATUS FOR STORE AND FORWARD IN NTN DEPLOYMENTS

(71) Applicant: SAMSUNG ELECTRONICS CO., LTD., Suwon-si, Gyeonggi-do (KR)

(72) Inventors: Jonas SEDIN, Staines, Middlesex (GB); Chadi KHIRALLAH, Staines, Middlesex (GB)

(21) Appl. No.: 19/149,428

(22) PCT Filed: Jan. 17, 2024
(86) PCT No.: PCT/KR2024/000818

§ 371 Date: Jul. 18, 2025

(30) Foreign Application Priority Data
Jan. 18, 2023 (GB) 2300747.9
Dec. 15, 2023 (GB) 2319314.7

(51) Int. Cl. H04W 48/02; H04W 76/20

(52) U.S. Cl. CPC H04W 48/02; H04W 76/20

(57) ABSTRACT

The disclosure relates to a 5G or 6G communication system for supporting a higher data transmission rate. The system comprises a first entity in a non-terrestrial network (NTN), the first entity configured to operate in a Store and Forward (S&F) mode based on being included in a satellite providing discontinuous coverage, wherein the first entity is configured to signal, to a second entity, information on the S&F mode at the first entity.

### TECHNICAL FIELD

Certain examples of the present disclosure relate to methods, apparatus and/or systems for supporting store and forward based procedures in a NTN deployment. Further, certain examples of the present disclosure relate to methods and apparatus for supporting store and forward based procedures in a discontinuous coverage NTN by putting RAN in a network entity such as a satellite or HAPS. Further, certain examples of the present disclosure relate to restricting and/or allowing certain network procedures for a UE based on a store ad forward mode of an eNB. Further, certain examples of the present disclosure delay or advance one or more parts of a resume procedure in a store and forward network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

The content of the following documents is referred to below and/or their content provides background information that the following disclosure should be considered in the context of:
[1] 3GPP TS 38.331-5G, NR, Radio Resource Control (RRC), Protocol Specification; Release 17 (e.g., V17.2.0).
[2] 3GPP TS 36.331—LTE, Evolved Universal Terrestrial Radio Access (E-UTRA), Radio Resource Control (RRC), Protocol Specification;
Release 17 (e.g., V17.2.0).
(Note: the example versions shown for each TS are non-limiting, other versions of the TS may be considered also)

Wireless or mobile (cellular) communications networks in which a mobile terminal (e.g., user equipment (UE), such as a mobile handset) communicates via a radio link with a network of base stations, or other wireless access points or nodes, have undergone rapid development through a number of generations. The 3^{rd} Generation Partnership Project (3GPP) design, specify and standardise technologies for mobile wireless communication networks. Fourth Generation (4G) and Fifth Generation (5G) systems are now widely deployed.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks.

LTE and 5G NR provide architectures and frameworks for non-terrestrial networks (NTNs) and usage thereof. A NTN may comprise one or more of, or a combination of, Lower Earth Orbit (LEO) satellites, Medium Earth Orbit (MEO) satellites, Geostationary Orbit (GEO) satellites, and High-Altitude Platform Systems (HAPS) (and/or other non-terrestrial network entities). Accordingly, access to a NTN may be through one or more LEO satellites, MEO satellites, GEO satellites and HAPS.

Internet of Thing (IoT) NTN was a 3GPP study and work item in 3GPP Release 17 to provide Non-Terrestrial Network access for E-UTRAN IoT devices (e.g., narrowband (NB)-IoT and Long Term Evolution for Machines (LTE-M)/Enhanced Machine-Type Communication (eMTC))—referring to 3GPP TSG RAN Meeting #90 RP-202689. NR NTN was a work item in Release 17 to specify adaptation to allow NR to function over NTN—referring to 3GPP TSG RAN meeting #91-e RP-211557. Following the work items in Release 17, there were work items to enhance NR NTN (referring to 3GPP TSG RAN Meeting #95e RP-220953) and IoT NTN (referring to 3GPP TSG RAN Meeting #95e RP-220979) in Release 18.

In Release 17 IoT NTN WI, the concept of discontinuous coverage was introduced. Discontinuous coverage is the scenario in which a satellite network, e.g., a LEO or MEO satellite network, is not able to provide continuous coverage due to not having enough satellites to cover the whole earth. As the coverage moves, this means that coverage will be on and off. As an example, if there is only a single LEO satellite, the UE may see coverage as seldom as once every 24 hours for several minutes depending on the satellite coverage characteristics.

FIG. 1A shows an illustration of discontinuous coverage for a case of a UE with two satellites, and FIG. 1B illustrates an example of Reference Signal Received Power (RSRP) measured by the UE over time, for the case shown in FIG. 1A.

In FIG. 1A, a first satellite 110 and a second satellite 120 are shown, with the path of the first satellite 110 and the second satellite 120 shown between dashed lines 141 and 143. The first satellite 110 controls a first cell 113, and the second satellite 120 controls a second cell 123. The UE 130 is located in/on the path of the satellites 110, 120.

As shown in FIG. 1B, due to movement of the first and second satellites 110, 120, the RSRP of the UE 130 (e.g., measured by the UE 130) will change over time as the UE 130 moves in and out of coverage of the first cell 113 and the second cell 123. An out-of-coverage period is represented by period 150, corresponding to the space between the two vertical dashed lines in FIG. 1B. These dashed lines represent the point, in time, when the RSRP drops below a value (e.g., a threshold value) such that the UE 130 is considered to be out of coverage. This may coincide with a drop in signal quality or connection.

To allow for power saving when there is no coverage, a UE is allowed to power down and not perform any Access Stratum functionality, such as measuring and trying to detect cells. For the UE to be able to know when there is coverage or not, the network signals long-term ephemeris parameters that allow the UE to predict future satellite passes up to several days in the future. This is signaled in a System information block (SIB) SIB32. In addition to ephemeris parameters, the network also signals coverage parameters that tells the UE how large the coverage is to better be able to estimate whether the satellite will provide coverage or not.

As NTN has a number of NTN-specific information elements that are only required when accessing an NTN cell, and also due to the rather large information elements, 3GPP agreed that new system information blocks (SIB) were needed.

In NR NTN, as defined in TS 38.331 [1], SIB19 contains the required information to access an NTN cell; an excerpt of TS 38.331 [1] discloses:
SIB19

SIB19 contains satellite assistance information for NTN access.

SIB19 information element

```
  -- ASN1START
  -- TAG-SIB19-START
  SIB19-r17 ::= SEQUENCE {
  ntn-Config-r17 NTN-Config-r17 OPTIONAL, -- Need R
  t-Service-r17 INTEGER (0..549755813887) OPTIONAL, -- Need R
  referenceLocation-r17 ReferenceLocation-r17 OPTIONAL, -- Need R
  distanceThresh-r17 INTEGER(0..65525) OPTIONAL, -- Need R
  ntn-NeighCellConfigList-r17 NTN-NeighCellConfigList-r17 OPTIONAL, -- Need R
  lateNonCriticalExtension OCTET STRING OPTIONAL,
  ...,
  [[
  ntn-NeighCellConfigListExt-v1720 NTN-NeighCellConfigList-r17 OPTIONAL -
Need R
  ]]
  }
  NTN-NeighCellConfigList-r17 ::= SEQUENCE (SIZE(1..maxCellNTN-r17)) OF
NTN-NeighCellConfig-r17
  NTN-NeighCellConfig-r17 ::= SEQUENCE {
  ntn-Config-r17 NTN-Config-r17 OPTIONAL, -- Need R
  carrierFreq-r17 ARFCN-ValueNR OPTIONAL, -- Need R
  physCellId-r17 PhysCellId OPTIONAL -- Need R
  }
  -- TAG-SIB19-STOP
  -- ASN1STOP
```

TABLE 1
SIB19 field descriptions

distanceThreshDistance from the serving cell reference location and is used in
location-based measurement initiation in RRC_IDLE and RRC_INACTIVE, as
defined in TS 38.304 [20]. Each step represents 50 m.
ntn-Config
Provides parameters needed for the UE to access NR via NTN access such as
Ephemeris data, common TA parameters, k_offset, validity duration for UL sync
information and epoch.
ntn-NeighCellConfigList, ntn-NeighCellConfigListExtProvides a list of NTN
neighbour cells including their ntn-Config, carrier frequency and PhysCellId. This set
includes all elements of ntn-NeighCellConfigList and all elements of ntn-
NeighCellConfigListExt. If ntn-Config is absent for an entry in ntn-
NeighCellConfigListExt, the ntn-Config provided in the entry at the same position in
ntn-NeighCellConfigList applies.
referenceLocationReference location of the serving cell provided via NTN quasi-
Earth fixed system and is used in location-based measurement initiation in
RRC_IDLE and RRC_INACTIVE, as defined in TS 38.304 [20].
t-ServiceIndicates the time information on when a cell provided via NTN quasi-Earth
fixed system is going to stop serving the area it is currently covering. The field
indicates a time in multiples of 10 ms after 00:00:00 on Gregorian calendar date 1
Jan., 1900 (midnight between Sunday, Dec. 31, 1899 and Monday, Jan.
1, 1900). The exact stop time is between the time indicated by the value of this field
minus 1 and the time indicated by the value of this field.

In IoT NTN, as defined in TS 36.331 [2], SIB31 contains the required information to access an IoT NTN cell; an excerpt of TS 36.331 [2] discloses:
SystemInformationBlockType31

The IE SystemInformationBlockType31 contains satellite assistance information for the serving cell. SystemInformationBlockType31 is only signalled in a NTN cell.

SystemInformationBlockType31 information element

-- ASN1START
SystemInformationBlockType31-r17 ::= SEQUENCE {
servingSatelliteInfo-r17 ServingSatelliteInfo-r17,
lateNonCriticalExtension OCTET STRING OPTIONAL,
...
}
ServingSatelliteInfo-r17 ::= SEQUENCE {
ephemerisInfo-r17 CHOICE {
stateVectors EphemerisStateVectors-r17,
orbitalParameters EphemerisOrbitalParameters-r17
},
nta-CommonParameters-17 SEQUENCE {
nta-Common-r17 INTEGER (0..8316827) OPTIONAL, -- Need OP
nta-CommonDrift-r17 INTEGER (−261935..261935) OPTIONAL, -- Need OP
nta-CommonDriftVariation-r17 INTEGER (0..29479) OPTIONAL -- Need OP
},
ul-SyncValidityDuration-r17 ENUMERATED {s5, s10, s15, s20, s25, s30, s35, s40,
s45, s50, s55, s60, s120, s180, s240, s900},
epochTime-r17 SEQUENCE {
startSFN-r17 INTEGER (0..1023),
startSubFrame-r17 INTEGER (0..9)
} OPTIONAL, -- Need OP
k-Offset-r17 INTEGER (0..1023),
k-Mac-r17 INTEGER (1..512) OPTIONAL, -- Need OP
...
}
-- ASN1STOP

TABLE 2
SystemInformationBlockType31 field descriptions

epochTime
Epoch time of the satellite ephemeris data and common TA parameters, see TS 36.213
[23]. The reference point for epoch time of the serving satellite ephemeris and
Common TA parameters is the uplink time synchronization reference point.
epochTime is the starting time of a DL subframe indicated by startSFN and start-
Subframe.
If the field is absent, the UE uses the starting time of the DL subframe corresponding
to the end of the SI window during which the SI message carrying SIB31 is
transmitted.
E-UTRAN always includes epochTime when SystemInformationBlockType31 is
provided through dedicated signalling.
k-MacScheduling offset used when downlink and uplink frame timing are not aligned
at the eNB, see TS 36.213 [23]. Unit in ms.
If the field if absent, the UE uses the (default) value of 0.
k-OffsetScheduling offset used in the timing relationships in NTN, see TS 36.213
[23]. Unit in ms.
nta-CommonNetwork-controlled common TA, see TS 36.213 [23]. Unit of μs.
Step of 32.55208 × 10⁻³ μs. Actual value = field value * 32.55208 × 10⁻³.
If the field is absent, the UE uses the (default) value of 0.
nta-CommonDriftDrift rate of the common TA, see TS 36.213 [23]. Unit of μs/s.
Step of 0.2 × 10⁻³ μs/s. Actual value = field value * 0.2 × 10⁻³.
If the field is absent, the UE uses the (default) value of 0.
nta-CommonDriftVariationDrift rate variation of the common TA, see TS 36.213
[23]. Unit of μs/s².
Step of 0.2 × 10⁻⁴ μs/s². Actual value = field value * 0.2 × 10⁻⁴.
If the field is absent, the UE uses the (default) value of 0.
orbitalParametersInstantaneous values of the satellite orbital parameters. The
signalled values are only valid for the duration as defined by ul-
SyncValidationDuration and epochTime.
stateVectorsInstantaneous values of the satellite state vectors. The signalled values
are only valid for the duration as defined by ul-SyncValidationDuration and
epochTime.
ul-SyncValidationDurationValidity duration of the satellite ephemeris data and
common TA parameters, i.e. maximum time during which the UE can apply the
satellite ephemeris without acquiring new satellite ephemeris, see TS 36.213 [23].
Unit in second.
Value s5 corresponds to 5 seconds, value s10 corresponds to 10 seconds and so on.

According to 15 36.331 [2], the system information SIB31 includes the following:
Serving cell Ephemeris elements—which allows UE to calculate the satellite position for doppler and time pre-compensation. This can be of two formats:
PVT format—which describes a (X,Y,Z) position as well as a speed vector (vX, vY, vZ);
Orbital parameters—this describes the orbital movements of the satellite which is then used to infer the satellite position.
TA common parameters—this provides the common timing advance parameters which is introduced to compensate for the feeder link delays. The signaling consists of (in total taking up 57 bits):
   Absolute TA common, taking up 23 bits;
   Drift of the TA common—how the TA common drifts, i.e., the first derivative, taking up 19 bits;
   Variation of the TA common—how the TA common varies, i.e., the second derivative of the TA common, taking up 15 bits.
Synchronization validity duration—used to define how long the ephemeris and TA common is valid.
Epoch time—when the synchronization validity duration should start.
K-Offset—scheduling offset for timing relationship in NTN.
K-Mac—Scheduling offset used when the downlink and uplink frame timing is not aligned.
NR NTN specific information which also includes (as part of 38.331):
   T-Service (signaled in SIB3 in IoT NTN);
   Reference location and distance threshold—used for location-based measurement initiation in RRC IDLE and RRC Connected mode;
   Neighbour cell ephemeris;
   This is used for idle mode measurements.

To enable discontinuous coverage, the discontinuous coverage NTN provides/uses a SIB called SystemInformationBlockType32. An excerpt of TS 36.331 [2] discloses:
SystemInformationBlockType32

The IE SystemInformationBlockType32 contains satellite assistance information for prediction of discontinuous coverage. SystemInformationBlockType32 is only signalled in a NTN cell.

SystemInformationBlockType32 information element

```
  -- ASN1START
  SystemInformationBlockType32-r17 ::= SEQUENCE {
  satelliteInfoList-r17 SatelliteInfoList-r17 OPTIONAL, -- Need OR
  lateNonCriticalExtension OCTET STRING OPTIONAL,
  ...
  }
  SatelliteInfoList-r17 ::= SEQUENCE (SIZE (1..maxSat-r17)) OF SatelliteInfo-r17
  SatelliteInfo-r17 ::= SEQUENCE {
  satelliteId-r17 INTEGER (0..255),
  serviceInfo-r17 SEQUENCE {
  tle-EphemerisParameters-r17 TLE-EphemerisParameters-r17 OPTIONAL, -- Need
OR
  t-ServiceStart-r17 TimeOffsetUTC-r17 OPTIONAL -- Need OR
  },
  footprintInfo-r17 SEQUENCE {
  referencePoint-r17 SEQUENCE {
  longitude-r17 INTEGER (−131072..131071),
  latitude-r17 INTEGER (−131072..131071)
  } OPTIONAL, -- Need OR
  elevationAngles-r17 SEQUENCE {
  elevationAngleRight-r17 INTEGER (−14..14),
  elevationAngleLeft-r17 INTEGER (−14..14) OPTIONAL -- Need OP
  } OPTIONAL, -- Need OR
  radius-r17 INTEGER (1..256) OPTIONAL -- Need OR
  }
  }
  -- ASN1STOP
```

TABLE 3
SystemInformationBlockType32 field descriptions

elevationAngleLeft, elevationAngleRightLeftmost and rightmost (with reference to
the satellite direction) elevation angle. Unit in degree.
Step of 5 degree. Actual value = field value * 5.
If the field elevationAngleLeft is absent, the leftmost elevation angle is equal to the
value of field elevationAngleRight.
footprintInfoSatellite footprint.
E-UTRAN may configure elevationAngles and/or radius for earth moving satellite.
E-UTRAN may configure referencePoint and radius for quasi earth fixed satellite.
latitudeLatitude of the reference point. Unit in degree.
Step of 360/262144 degree. Actual value = field value * (360/262144).
longitudeLongitude of the reference point. Unit in degree.
Step of 360/262144 degree. Actual value = field value * (360/262144).
radiusDistance between the reference point and the edge of the satellite or beam
coverage. Unit in km.
Step of 10 km. Actual value = field value * 10.
serviceInfoInformation on when the satellite will provide coverage.
E-UTRAN always configures tle-EphemerisParameters for a satellite with earth
moving cell(s) and always configures t-ServiceStart for a quasi-earth fixed satellite.
tle-EphemerisParameters
Mean values of the satellite orbital parameters based on the TLE set format for
estimating in-coverage and out-of-coverage periods for a satellite with earth moving
cell(s), see TS 36.304 [4].
t-ServiceStartTime information on when the incoming satellite is going to start
serving the area for quasi-earth fixed satellite.

According to TS 36.331 [2], SIB32 includes the following information elements:
SatelliteId—This is used to tie an ephemeris field to an ID, such that if multiple satellites are provided and the list is updated, the UE may replace or create a new entry.
TLE ephemeris parameters—this provides the TLE (Two Line Element) parameters for a satellite orbit and is used for earth-moving cells.
T-ServiceStart—this provides the time when the area will served for quasi-earth fixed cells.
footprintInfo—provides info on the size and geometry of the satellite coverage:
   referencePoint and radius—provides the reference point as well as radius of the satellite coverage area;
   elevationAngles—this is used in earth moving cell to define the coverage area.

While discontinuous coverage allows for UE power savings in deployments where there are not enough satellites to cover the whole earth, there are still some basic issues in order to provide cost-effective IoT NTN solutions.

### DISCLOSURE OF INVENTION

### Technical Problem

In line with development of the communication systems, there is a need for supporting store and forward based procedures in a NTN deployment.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

According to an example of the present disclosure, there is provided a first entity in a non-terrestrial network (NTN), wherein the first entity is configured to operate in a Store and Forward (S&F) mode based on being included in a satellite providing discontinuous coverage; and wherein the first entity is configured to signal, to a second entity, information on the S&F mode at the first entity. According to another example of the present disclosure, there is provided a second entity configured to support a store and forward (S&F) mode, the second entity comprising: a receiver; a transmitter; and a controller configured to: receive, from a first entity in a non-terrestrial network (NTN), information on a S&F mode at the first entity; and perform one or more procedures with the first entity based on the information on the S&F mode at the first entity. Other examples are disclosed herein.

It is an aim of certain examples/embodiments/aspects etc. of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

According to an aspect of the present disclosure, there is provided a first entity in a non-terrestrial network (NTN), wherein the first entity is configured to operate in a Store and Forward (S&F) mode based on being included in a satellite providing discontinuous coverage; and wherein the first entity is configured to signal, to a second entity, information on the S&F mode at the first entity.

According to various examples, the information on the S&F mode at the first entity comprises one or more of: an indication that the first entity is or serves a S&F satellite, a S&F eNB, or a S&F cell, or that the first entity serves a S&F tracking area (TA), a S&F registration area (RA) or a S&F public land mobile network (PLMN); an indication that the first entity is entering the S&F mode; a list including one or more of allowed procedures, not allowed procedures, or restricted procedures on the first entity, the S&F satellite, the S&F eNB, the S&F cell, the S&F TA, the S&F RA or the S&F PLMN; an indication that uplink data to be forwarded by the first entity is S&F data; or an indication that downlink data will be stored and forwarded by the first entity.

According to various examples, the indication is signalled via a flag, in a system information block (SIB), or implicitly via an information element specific to S&F.

According to various examples, the first entity, when configured to operate in a S&F mode, is configured to perform one or more of the following procedures: tracking area update, downlink data transfer, or uplink data transfer.

According to various examples, the first entity is configured to signal, to a user equipment (UE), an indication that the UE: can operate in a S&F network, can operate with the first entity, or can operate with the satellite.

According to various examples, wherein when operating in the S&F mode, the first entity is configured to store a UE context for the UE; wherein the indication is signalled via non-access stratum (NAS) or in a RRCConnectionRelease message; and/or wherein the UE is the second entity or is different to the second entity.

According to various examples, the first entity is further configured to: when operating in the S&F mode in the satellite: perform RRC connection resume procedure with a UE in response to receiving an RRC connection resume request from the UE; receive uplink data from the UE; and transmit RRCConnectionRelease message to the UE; based on detecting that the satellite is within coverage of a ground station, perform UE context resume procedure with the second entity; and forward the uplink data to the second entity; wherein the information indicates that the uplink data is S&F data, and the information is signalled in the UE context resume procedure.

According to various examples, the first entity is further configured to: further configured to: when communicably connected to a ground station: perform UE context resume procedure with the second entity; and receive and store downlink data from the second entity; based on detecting that the satellite is leaving coverage of the ground station, enter the S&F mode; perform RRC connection resume procedure with the UE in response to receiving an RRC connection resume request from the UE; and forward the downlink data to the UE; wherein the information indicates that the downlink data will be stored and forwarded when the first entity is communicably connected with the UE, and the information is signalled in the UE context resume procedure.

According to various examples, the first entity is further configured to: further configured to: when operating in the S&F mode in the satellite while out of coverage of a ground station, receive a tracking area update from a UE; detect the satellite is within coverage of the ground station and, in response, connect to the ground station; forward the tracking area update to the second entity; receive a tracking area accept from the second entity; detect the satellite is leaving the coverage of the ground station and, in response, enter the S&F mode; and when communicably connectable with the UE, forward the tracking area accept to the UE.

According to various examples, wherein the first entity is a logical network entity; and wherein the first entity is configured to: be transferred from a ground station to the satellite, to be included in the satellite, based on detecting that the satellite is leaving coverage of the ground station; and/or be transferred from the satellite to the ground station, to be included in the ground station, based on detecting that the satellite is entering coverage of the ground station.

According to various examples, when included in the ground station, the first entity is configured to: detect the satellite will be leaving coverage of the ground station; in response the detection, enter the S&F mode and signal the information to the second entity; and receive, from the second entity, a message regarding transferring to the satellite.

According to various examples, the first entity is the satellite; and/or the first entity is an eNB

According to various examples, the second entity is a mobility management engine (MME) or core network (CN); and the first entity is configured to receive, from the second entity in response to the information, one or more UE contexts for respectively communicating with one or more UEs.

According to another aspect of the present disclosure, there is provided a second entity configured to support a store and forward (S&F) mode, the second entity comprising: a receiver; a transmitter; and a controller configured to: receive, from a first entity in a non-terrestrial network (NTN), information on a S&F mode at the first entity; and perform one or more procedures with the first entity based on the information on the S&F mode at the first entity.

According to various examples, the information on the S&F mode at the first entity comprises one or more of: an indication that the first entity is or serves a S&F satellite, a S&F eNB, or a S&F cell, or that the first entity serves a S&F tracking area (TA), a S&F registration area (RA) or a S&F public land mobile network (PLMN); an indication that the first entity is entering the S&F mode; a list including one or more of allowed procedures, not allowed procedures, or restricted procedures on the first entity, the S&F satellite, the S&F eNB, the S&F cell, the S&F TA, the S&F RA or the S&F PLMN; an indication that uplink data, to be forwarded to the second entity by the first entity, is S&F data; or an indication that downlink data for a third entity will be stored and then forwarded when the first entity is communicably connected with the third entity.

According to various examples, the procedure is one of: a tracking area update; downlink data transfer; uplink data transfer; RRC connection resume procedure; UE context resume procedure; or RRC connection release procedure.

According to various examples, the second entity is a user equipment (UE); wherein the controller is configured to: receive, from the first entity or from a third entity, indication that the UE: can operate in a S&F network, can operate with the first entity, or can operate with the satellite.

According to various examples, the indication is signalled via non-access stratum (NAS) or in a RRCConnectionRelease message.

According to various examples, the second entity is a UE; wherein the controller is configured to: during an idle mode or inactive mode operation at the UE, de-prioritize the first entity or a cell of the first entity based on the information on the S&F mode at the first entity; and/or consider the first entity to be barred by the UE, based on the information on the S&F mode at the first entity. For example, the first entity or the cell is de-prioritised due to operating in the S&F mode. For example, the first entity is barred by the UE due to operating in the S&F mode.

According to various examples, the second entity is a mobility management engine (MME) or Core Network (CN); and the controller is configured to transmit, to the first entity in response to the information, one or more UE contexts for respectively communicating with one or more UEs.

According to various examples, the controller is configured to: perform UE context resume procedure with the first entity; and transmit downlink data to the first entity; and wherein the information indicates that the downlink data will be stored and forwarded when the first entity is communicably connected with the UE, and the information is received in the UE context resume procedure.

According to various examples, the controller is configured to: perform UE context resume with the first entity; and receive uplink data from the first entity; and wherein the information indicates that the uplink data is S&F data, and the information is received in the UE context resume procedure.

According another aspect of the present disclosure, there is provided a method of a first entity in a non-terrestrial network (NTN), the first entity configured to operate in a Store and Forward (S&F) mode based on being included in a satellite providing discontinuous coverage, wherein the method comprises: signalling, to a second entity, information on the S&F mode at the first entity.

According to various examples, the method further comprises features of any of the above examples relating to the first entity.

According to another aspect of the present disclosure, there is provided a method of a second entity configured to support a store and forward mode, the method comprising: receiving, from a first entity in a non-terrestrial network (NTN), information on a S&F mode at the first entity; and performing one or more procedures with the first entity based on the information on the S&F mode at the first entity.

According to various examples, the method further comprises features of any of the above examples relating to the second entity.

According to another aspect of the present disclosure, there is provided a computer program comprising instructions which, when the program is executed by a computer or processor, cause the computer or processor to carry out a method according to any one or more of the above methods.

According to another aspect of the present disclosure, there is provided a network comprising a first entity according to any one or more of the above examples or aspects and a second entity according to any one or more of the above examples or aspects.

It will be appreciated that the present disclosure envisages and includes at least all combinations of the above examples and aspects.

Other aspects, advantages, and salient features of the invention will become apparent to those skilled in the art from the following detailed description taken in conjunction with the accompanying drawings.

### Advantageous Effects of Invention

The present disclosure provides an effective and efficient method for supporting store and forward based procedures in a NTN deployment. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

Embodiments/examples of the present disclosure are further described hereinafter with reference to the accompanying drawings, in which:

FIG. 1 is a representation of discontinuous satellite coverage according to an example of the disclosure;

FIG. 2 is a representation of ground station deployment according to an example of the present disclosure;

FIG. 3 includes illustrations of example methods (a) and (b) of an eNB indicating to MME regarding Store and Forward mode in accordance with examples of the present disclosure.

FIG. 4 is an illustration of a method for a UE to connect to a Store and Forward satellite in accordance with an example of the present disclosure.

FIG. 5A shows a legacy resume procedure relating to UL data according to an example of the disclosure.

FIG. 5B is an illustration of a UL data procedure in a Store and Forward network in accordance with an example of the present disclosure.

FIG. 6A shows a legacy resume procedure relating to DL data according to an example of the disclosure.

FIG. 6B is an illustration of a DL data procedure in a Store and Forward network in accordance with an example of the present disclosure.

FIG. 7 is an illustration of a resume procedure for tracking area updates in accordance with an example of the present disclosure.

FIG. 8 is a block diagram illustrating an example structure of a network entity in accordance with certain examples of the present disclosure.

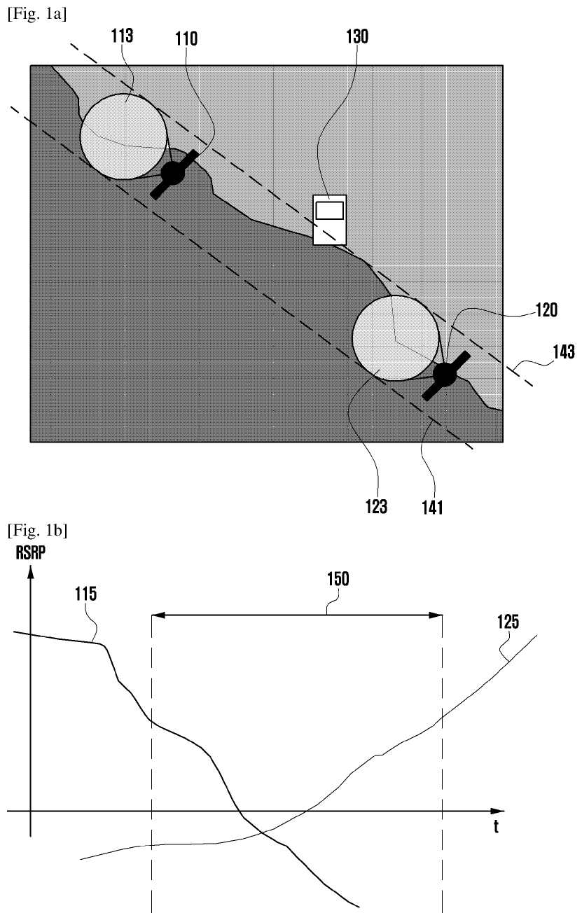

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### MODE FOR THE INVENTION

The following description of examples of the present disclosure, with reference to the accompanying drawings, is provided to assist in a comprehensive understanding of certain examples of the present invention. The description includes various specific details to assist in that understanding but these are to be regarded as merely exemplary. Accordingly, those of ordinary skill in the art will recognize that various changes and modifications of the examples described herein can be made without departing from the scope of the invention or disclosure.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but are merely used to enable a clear and consistent understanding of the invention.

Throughout the description of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description of this specification, the singular form, for example “a”, “an” and “the”, encompasses the plural unless the context otherwise requires. For example, reference to “an object” includes reference to one or more of such objects.

Throughout the description, the expression “at least one of A, B and/or C” (or the like) and the expression “one or more of A, B and/or C” (or the like) should be seen to separately include all possible combinations, for example: A, B, C, A and B, A and C, A and B and C.

Throughout the description of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment or example are to be understood to be applicable to any other aspect, embodiment or example described herein unless incompatible therewith.

Certain examples of the present disclosure relate to methods, apparatus and/or systems etc. for supporting store and forward based procedures in a NTN deployment. Further, certain examples of the present disclosure relate to methods and apparatus for supporting store and forward based procedures in a discontinuous coverage NTN by putting RAN in a network entity such as a satellite or HAPS. In certain examples, CN elements are not put in the network entity. Further, certain examples of the present disclosure relate to restricting and/or allowing certain network procedures for a UE based on a store and forward mode of an eNB. Further, certain examples of the present disclosure delay or advance one or more parts of a resume procedure in a store and forward network (e.g., a NTN).

The following examples are applicable to, and use terminology associated with, 3GPP 4G (e.g., LTE) and/or 5G (e.g., NR). However, the skilled person will appreciate that the techniques disclosed herein are not limited to these examples or to 3GPP 4G (e.g., LTE) and/or 5G (e.g., NR), and may be applied in any suitable system or standard, for example one or more existing and/or future generation wireless communication systems or standards. The skilled person will appreciate that the techniques disclosed herein may be applied in any existing or future releases of 3GPP 4G (e.g., LTE) and/or 5G (e.g., NR) or any other relevant standard. For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present invention is not limited to the specific examples disclosed herein. For example:
The techniques disclosed herein are not limited to 3GPP 4G or 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g., a network) comprising one or more such apparatuses/devices/network entities, and/or a method therefor.

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, example and/or embodiment disclosed herein. Certain embodiments of the present disclosure provide a machine-readable storage storing such a program.

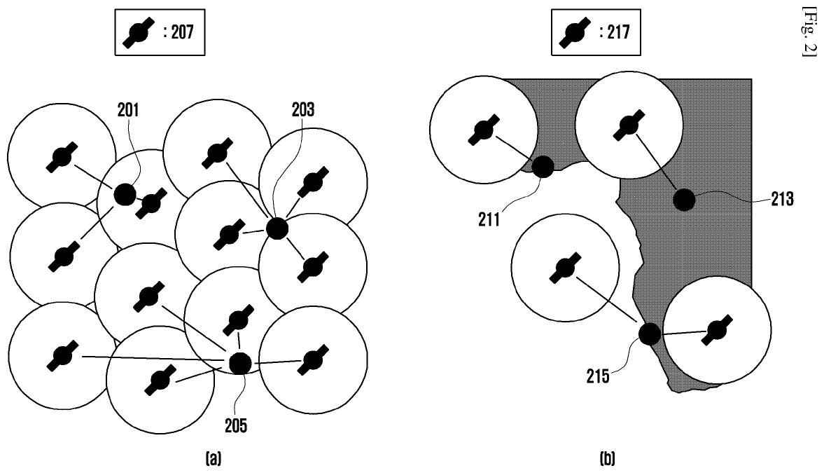

As discussed above, discontinuous coverage allows for power saving for a UE in NTN deployments where there are not enough satellites to cover the whole earth, but there are still some basic issues in order to provide cost-effective IoT NTN solutions. A main issue of a known NTN deployment is that the satellites providing discontinuous coverage still need to have connectivity with a ground gateway in order to perform any type of communication. Considering only coverage, the amount of ground stations is the same for a discontinuous coverage satellite network as for a fully continuous coverage network. This is illustrated in FIG. 2.

In FIG. 2, (a) shows a case of continuous coverage, where each satellite 207 is in connected to one of the three ground stations (or ground gateways) 201, 203, 205 (note: numeral 207 is used for each of the twelve satellites illustrated in (a) of FIG. 2, but alternatively these satellites could be individually numbered 207-1, 207-2, . . . , 207-n, where n is equal to the total number of satellites). A corresponding cell or coverage is shown for each satellite 207.

In (b) of FIG. 2, a case of discontinuous coverage is shown with only four satellites 217 (this number is arbitrarily chosen to demonstrate discontinuous coverage); however, three ground stations (or ground gateways) 211, 213, 215 are still provided, with each satellite 217 connected to one of the three base stations 211, 213, 215 (note: numeral 217 is used for each of the four satellites illustrated in (b) of FIG. 2, but alternatively these satellites could be individually numbered 217-1, 217-2, . . . , 217-m, where m is equal to the total number of satellites). A corresponding cell or coverage is again shown for each satellite 217.

Accordingly, it can be seen how the amount of ground stations/gateways (e.g., eNBs, gNBs etc.) is the same regardless of whether the NTN provides continuous coverage or discontinuous coverage.

In T. Kellermann et al, “Novel Architecture for Cellular IoT in Future Non-Terrestrial Networks: Store and Forward Adaptations for Enabling Discontinuous Feeder Link Operation”, a ‘Store and Forward’ approach to address the above issue is presented, in which certain core network (CN) elements are placed in the satellite. In summary, the following is proposed in T. Kellermann et al:
Dealing with UE Non-Access Stratus (NAS) and Mobility Management Engine (MME) timers (TXXXX, etc) due to the delays of completing core network procedures.
MME entity or MME functions being put in the satellite.
Requiring MME on the satellite to synchronize with central MME entity.
NAS procedures can be performed with the entity in the satellite.
Regenerative RAN architecture (i.e., eNB is in the satellite).
Home Subscriber Service (HSS) (i.e., EPC entity that deals with Authentication of a UE entity) is on the ground, where the satellite will store and forward the packets (between MME and HSS) related to these procedures.
Storing and forwarding user plane in the satellite.
Solution for maintaining UE context across MMEs in satellites.

Some problems with this approach are as follows:
Certain Core Network elements need to be put in the satellite, greatly increasing Core Network and satellite complexity and requiring synchronization of the Core Network elements;
   this requires a lot of integration that may be challenging for an implementer, especially as Core Network and RAN are often separate entities, and
   this may be challenging to function with a legacy terrestrial Core Network.
Basic Core network procedures need some changes.

Accordingly, certain examples of the present disclosure provide methods, systems, apparatus etc. which provide Store and Forward based solutions in which only the RAN is put (e.g., implemented in) a satellite. Other examples of the present disclosure provide methods, systems, apparatus etc. which provide Store and Forward based solutions independently of whether or not only the RAN is put (e.g., implemented in) a satellite. Examples of the present disclosure therefore provide a more efficient solution to the above-identified problem, by not requiring CN elements to be put in a satellite. Store and Forward is typically abbreviated herein as SoF, however it will be appreciated that Store and Forward can also be abbreviated S&F or similar.

Herein, reference to an eNB should be regarded as reference to any base station, such as a gNB. It will be appreciated that, where reference is made to providing or putting an/the eNB in a/the satellite, this may be regarded as putting a network entity (not limited to an eNB) which provides the functionality of a eNB (or similar) in a/the satellite. In some embodiments, the eNB may be a virtual or logical network entity.

Additionally, references to a MME will be understood to also allow for options/examples/alternatives where another suitable network entity (including a virtual or logical network entity) is implemented/employed instead. For example, an Access and Mobility Function (AMF), or other suitable network function, may be used instead. Similarly, reference to a UE will be understood to also allow for options/examples/alternatives where another suitable network entity is implemented/employed instead; for example, a repeater or other node (which, in some examples, may also be regarded as examples of a UE).

Additionally, in the present disclosure, the notion/concept of Store and Forward satellite may also be referred to as a “discontinuous feeder link”, “intermittent feeder link” etc. In other words, such terminology may be used interchangeably or in a related manner, and other terminology may also be used if desired.

Certain embodiments of the present disclosure provide, but are not limited to, methods to allow RAN-based Store and Forward techniques based on Radio Resource Control (RRC) suspend/resume. Accordingly, only the eNB is put in the satellite and any packets on interfaces in-between eNB and other nodes in the Core Network are thus “stored” and later on “forwarded”. This can also be considered to be a proxy interface that performs the same actions

In various examples, an eNB signals that it is a Store and Forward (SoF) satellite, Store and Forward eNB or Store and Forward cell (i.e., the eNB will indicate an associated Store and Forward capability/arrangement). This is useful for a number of reasons as will be explained below.

Since only the eNB is in the satellite, according to various embodiments there are a number of procedures (e.g., associated with a UE, associated with the eNB, or associated with the network in general) that may either not be performed at all, or may be restricted or may alternatively be considered to take a lot of time. These procedures may include one or more of the following:
Attach procedures (Core Network procedures),
Detach procedures (Core Network procedures),
Service request procedures (Core Network procedures),
Inter-satellite handovers (RAN procedures).

In some examples, the above examples of Core Network procedures may be initiated (mostly) by a UE(s), e.g., by sending a NAS message transparently to the MME. In some examples the above example of RAN procedure may be initiated by a first eNB with a second eNB to handover a UE, where indications(s) to a MME may also be involved. Accordingly, in various embodiments, it will be appreciated that a restricted procedure may be regarded as being associated with an initiating entity.

As a result, according to various examples of the present disclosure, if the UE needs to perform one of these procedures, the UE needs to perform them either in a very slow fashion (due to the many exchanges with MME back and forth), or will need to perform them when connecting with a satellite that is connected to a ground station. Thus, in one embodiment, the UE is only allowed to perform one or more of the above procedures when the satellite is not included in a SoF network. The above procedures may also, for example, be performed with a terrestrial network or with a geostationary network with poor coverage, and thereafter proceed to only utilize the SoF satellite. In other words, the function that the above procedures perform may be considered preloaded.

According to various embodiments, to facilitate restricting one or more procedure, the eNB may signal or indicate, e.g., in a broadcast, to the UE, MME or other network entity, that it belongs to (or serves) a Store and Forward satellite, a Store and Forward eNB, a Store and Forward cell(s) (or Tracking Area(s), Registration Area(s), country(-ies)). For instance, the eNB may broadcast, in system information, an indication that it is a SoF cell or a SoF eNB or a SoF satellite etc. In some examples, the eNB may additionally (or even alternatively) signal a list of procedures which are allowed or not allowed/restricted on this Store and Forward satellite, eNB, and/or cell(s) (or Tracking Area(s), Registration Area(s), country(-ies)).

In various examples, the above indication/information can be signaled via a flag, or be implicit based on an information element (such as a SystemInformationBlock, SIB) specific to Store and Forward (or similar). Regarding where such an indication is sent, it may be signaled in any SIB(s), including but not limited to SIB1, SIB31 (i.e., NTN-specific SIB) or SIB32 (i.e., SIB for discontinuous coverage). As an example for using discontinuous coverage signaling, the eNB may indicate the upcoming satellite/eNB/cells. An upcoming satellite may be regarded, for instance, as a satellite that will pass by the UE/the area/the area where a UE operates. In another definition, an upcoming satellite may be a satellite that will serve the UE in the future (e.g., satellites are usually in orbits that allow a network or a UE to predict roughly when a new satellite will arrive to serve the UE) as being a Store and Forward satellite/eNB/cells. In another example, this information may be indicated in an idle mode (or inactive mode) configuration, e.g., such as provided by RRCConnectionRelease.

In other examples, a public land mobile network (PLMN) or frequency is considered to operate in a Store and Forward manner, and so signalling may be provided to indicate this. In further examples, certain area(s) (e.g. Tracking Area (TA), Registration Area (RA), or a country) may operate in a Store and Forward manner, and so signalling may be provided to indicate this. This may require more advanced signaling (e.g., requiring the signalling of more information than in the examples above), but has the benefit that it is clear to a UE where the Store and Forward can be operated (e.g., throughout a PLMN, a TA, a TA, or a country, or on an indicated frequency).

In certain embodiments, the indication that a specific satellite (or eNB, or cell) is a Store and Forward entity can be used by the UE (e.g., in addition to the UE using the indication to identify the Store and Forward nature of the satellite) to de-prioritize cells operating in this mode, for instance in an idle mode or inactive mode operation such as cell selection or cell reselection. This may be especially useful if the UE needs to perform any of the procedures that may be restricted (as discussed above). In various examples, for certain services (e.g., for providing or performing specified (e.g., set, predetermined, instructed etc.) services), the SoF satellite/eNB/cell may be considered barred (e.g., by the UE). Examples of such services include time-sensitive services, such as emergency indications, voice (VoIP, VoLTE) services.

In various examples, certain procedures (e.g., associated with a UE, associated with the eNB, or associated with the network in general) may be allowed for a SoF satellite (or eNB, or cell). It will be appreciated that various examples include both allowed procedures and restricted procedure(s) (i.e., restricted procedure(s) such as discussed above). Examples of allowed procedures are as follows (i.e., may include one or more of the following):
Tracking Area Update,
Downlink data transfer,
Uplink data transfer.

In certain embodiments, to support or facilitate a UE to operate in a Store and Forward NTN, signalling may be required for the UE. For example, one or more of the following examples of signalling may be provided to/by the UE (the signalling may be performed separately (e.g., each indication included in a separate message) or in any combination (e.g., several indications included in a single message)):
Signalling indicating to the UE that it can operate in a Store and Forward network and/or operate with a store and forward satellite (or SoF eNB, or SoF cell), e.g., an indication for this may be sent to the UE.
Signalling indicating under which conditions the UE can operate in a Store and Forward network, for instance:
   an indication of how long the UE can operate in a Store and Forward network, and/or
   an indication of the geographical areas that Store and Forward can operate (i.e., in which the UE may operation in a SoF network, or in which the SoF network may operate).
The UE may indicate that it is capable of operating in a Store and Forward network. Such an indication may be provided to the eNB and then to MME, where the MME may make the decision whether the UE is to operate in a SoF network.

In various examples, the above may be signaled when the UE is released/re-directed through RRCConnectionRelease, over from MME over NAS or broadcasted in SystemInformationBlocks.

In certain embodiments of the present disclosure, the Store and Forward related methods are based on RRC procedures, such as RRC resume procedures, whereby a satellite (i.e., eNB) retains (e.g., stores) the UE context of the UE(s) it communicates with. For this, in some examples, the UE may need to be capable of RRC resume procedures in order to perform Store and Forward communication.

Thus, in one embodiment, a UE may operate under a Store and Forward “mode” (i.e., being served by a SoF satellite, SoF eNB, SoF cell etc.) only if the eNB (i.e., the eNB and/or satellite) has the UE context available (or valid UE context). In one embodiment, the UE may be allowed to be in a Store and Forward “mode” if the UE has had its RRC connection suspended. For example, this may be signaled in a RRCConnectionRelease message or in a NAS message from CN.

In one consideration, as the Core Network should function as a normal terrestrial Core Network, there may not be enough knowledge when a satellite is leaving the ground network.

To enable Store and Forward operation the eNB may need to be in the satellite, i.e., a so-called regenerative architecture. Thus in one embodiment, the eNB is transferred dynamically to the Store and Forward satellite. This may occur when the eNB/satellite is about to leave the coverage of a ground station. In further embodiments, the eNB may be similarly transferred back to the ground station when it/the satellite reaches the coverage of the ground station.

In other words, in certain examples it may be considered that the eNB is a role which can be transferred between different network entities, such as between a ground station and a satellite. For example, the eNB is a logical network entity or a virtual network entity. The transfer may be triggered by the eNB entity itself, or may be triggered by another network entity (such as an MME).

In other embodiments, the eNB may announce to the MME that it is entering Store and Forward mode. In an example, the MME may inform other network entities and/or functions that the eNB may be or is entering Store and Forward mode. It will be appreciated that another network entity, other than a MME, may be implemented herein instead. For example, the eNB (or gNB) may announce to an Access and Mobility Function (AMF) or other suitable network function (NF).

In another example, the MME, knowing that the eNB is entering Store and Forward mode, may postpone, store, cancel, reject, or terminate any NAS procedures or signaling exchange with the eNB and/or UE.

The above (e.g., transferring of eNB to satellite etc.) can for instance be sent over the S1AP interface, for instance in any of the following messages/procedures:
eNB Configuration Update procedure (ENB CONFIGURATION UPDATE),
S1 setup request procedure (S1 SETUP REQUEST).

When eNB indicates to the MME that it will enter Store and Forward mode, the MME can pre-load (pre-configure/forward to) the eNB with UEs contexts that will be required to communicate with the desired UEs.

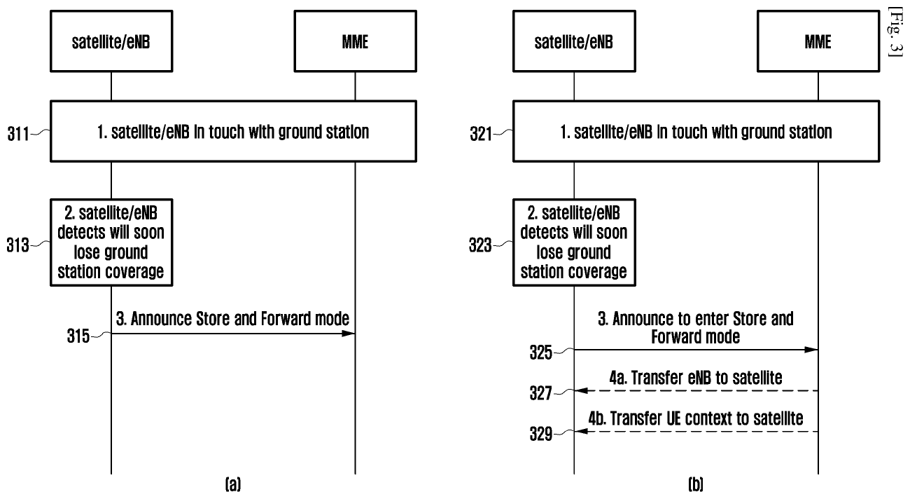

Some examples in accordance with the present disclosure are shown in FIG. 3, which shows examples of eNB indications to MME when entering or about to enter SoF mode.

In (a) of FIG. 3, in step 1 (311) a satellite/eNB is initially in touch with a ground station (e.g., has a connection to MME or other suitable network entity (e.g., AMF)). In step 2 (313), the satellite/eNB detects that it will soon lose ground station coverage. In step 3 (315), the satellite/eNB informs, announces etc., to the MME, that it will enter SoF mode.

In step 1 (321) of (b) of FIG. 3, a satellite/eNB is initially in touch with a ground station (e.g., has a connection to MME or other suitable network entity (such as AMF)). In step 2 (323), the satellite/eNB detects that it will soon lose ground station coverage. In step 3 (325), informs, announces etc., to the MME, that it will enter SoF mode. In step 4a (327), the MME messages the satellite/eNB regarding transferring the eNB to the satellite. In step 4b (329), the MME messages the satellite/eNB regarding transferring UE context to the satellite.

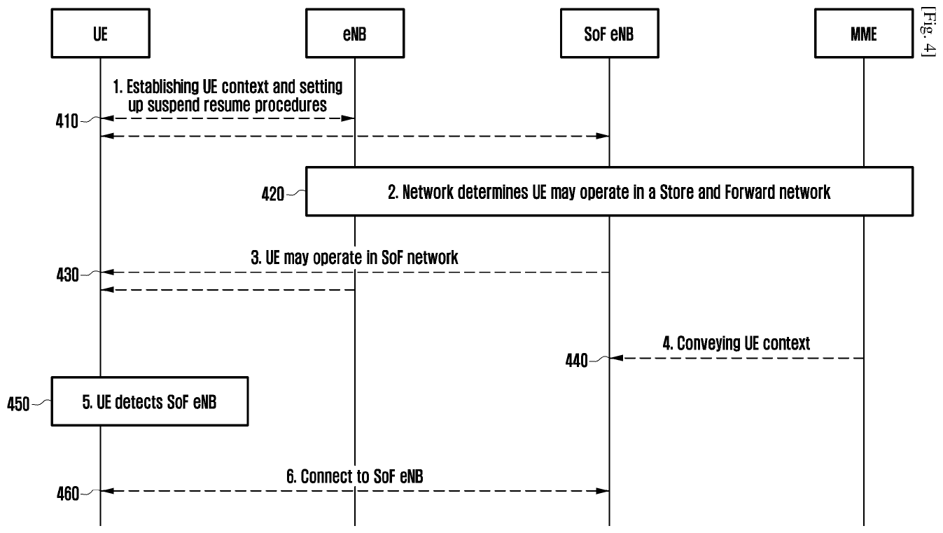

FIG. 4 illustrates an example of a procedure for a UE to connect to a Store and Forward satellite in accordance with examples of the present disclosure.

In operation 1 (410), UE context may be established and RRC suspend resume procedures may be set up.

In operation 2 (420), the network may determine whether the UE may operate in a store and forward network. In one example, this may be determined by whether UE will be in an area where Store and Forward operates; in another example, this may be determined by the services the UE requires.

In operation 3 (430), the network may signal that the UE may operate in a store and forward network. For example, this signalling may be done via NAS or through eNB in a RRCConnectionRelease message.

In operation 4 (440), the MME conveys the required UE context to the SoF eNB (e.g., satellite). In an example, this step may be performed when the network determines that the UE is allowed to operate in a SoF network.

In operation 5 (450), the UE may detect the SoF eNB.

In operation 6 (460), the UE may connect to the SoF eNB.

It will be appreciated that one or more of the operations shown in FIG. 4 may be omitted, replaced, re-ordered, thereby providing additional examples of the present disclosure. To give but one example, various embodiments include operations 2 and 3, simply relating to determining and signalling that the UE may operate in a SoF network. Of course, all other combinations of steps are considered herein.

According to certain embodiments, in order for the signaling to function correctly, some procedures with the core network may need to be performed in advance and/or some procedures may need to be performed delayed.

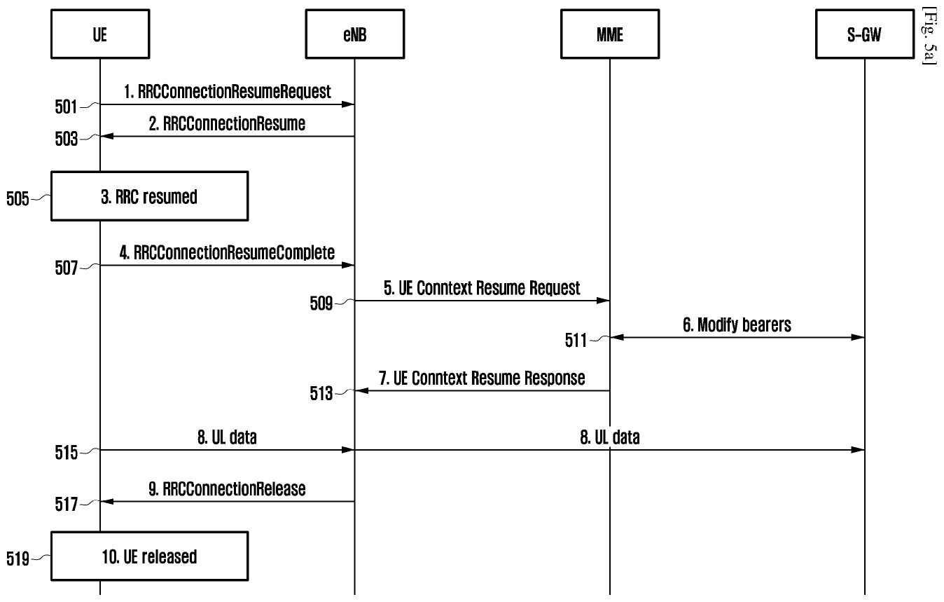

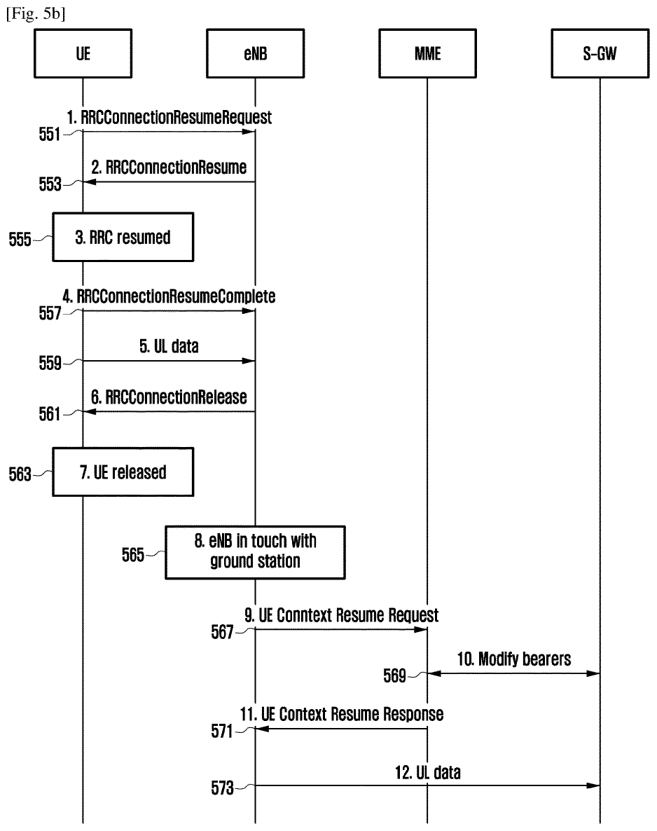

For uplink, for instance, in a legacy network the procedures to resume the UE context are performed before uplink data is transmitted by the UE to the eNB. An example of this is shown in FIG. 5A. However, in a Store and Forward this may be infeasible.

Accordingly, in embodiments of the present disclosure, the UE context Resume procedures are delayed until the eNB reaches a/the ground gateway and is connected to the MME. An example of this is illustrated in FIG. 5B, which shows an example method flow for a resume procedure for uplink data in a store and forward network in accordance with various embodiments of the present disclosure.

In FIG. 5A, showing a legacy resume procedure, in step 1 (501) a UE may send a RRCConnectionResumeRequest message to an eNB. In step 2 (503), the eNB may send a RRCConnectionResume message to the UE. In step 3 (505), RRC is resumed, e.g., the UE may resume SRBs and DRBs, Access Stratum security (AS Security) may be resumed and UE may enter RRC_CONNECTED. In step 4 (507), the UE may transmit RRCConnectionResumeComplete message to the eNB. In step 5 (509), the eNB may transmit UE Context Resume Request message to the MME. In step 6 (511), the MME (and SGW) may modify bearers (e.g., for the UE). In step 7 (513), the MME may send UE Context Resume Response to the eNB. In step 8 (515), the UE may send uplink (UL) data to the eNB, while the eNB may forward this data until is reaches SGW. In step 9 (517), the eNB may transmit RRCConnectionRelease message to the UE. In step 10 (519), UE release occurs.

FIG. 5A is provided to allow for comparison with embodiments of the present disclosure such as shown in FIG. 5B, which shows an example of UL data procedure in a Store and Forward network using RRC Resume.

Referring to FIG. 5B, in step 1 (551) a UE may send a RRCConnectionResumeRequest (e.g., in a message, RRC message etc.) to an eNB (e.g., over Uu interface).

In step 2 (553), the eNB may send a RRCConnectionResume (e.g., in a message, RRC message etc.) to the UE (e.g., over Uu interface).

In step 3 (555), the UE may resume SRBs and DRBs, AS sec (AS Security) may be re-established and UE may enter RRC_CONNECTED.

In step 4 (557), the UE may transmit RRCConnectionResumeComplete (e.g., in a message, RRC message etc.) to the eNB (e.g., over Uu interface).

In step 5 (559), the UE may transmit UL data to the eNB (e.g., over Uu interface). As such, it can be seen that the UE context Resume procedures are delayed in various embodiments.

In step 6 (561), the eNB may transmit RRCConnectonRelease (e.g., in a message, RRC message etc.) to the UE (e.g., over Uu interface), for example when the UL data has been received.

In step 7 (563), UE release occurs. For example, the UE is released with the RRC connection suspended.

Steps 1 to 7 may be performed, for example, while the eNB is operating in a SoF state (i.e., eNB is put in a satellite).

In step 8 (565), the eNB may determine or detect that it is in touch with a ground station. Optionally, the eNB may be transferred to the ground station.

In step 9 (567), the eNB may transmit UE Context Resume Request (e.g., in a message) to an MME (e.g., via S1 interface). For example, the eNB may indicate that the data (UL data) is Store and Forward data. This may inform the core network that it may be unable to reach the UE at the current point/time.

In step 10 (569), the MME and SGW may modify bearers (e.g., based on the UE context Resume Request).

In step 11 (571), the MME may send UE Context Resume Response to the eNB (e.g., over S1 interface).

In step 12 (573), the eNB may deliver (e.g., transmit, forward etc.) the UL data to the SGW (e.g., from eNB to MME to SGW).

Accordingly, it can be seen how procedures in accordance with various embodiments of the present disclosure differ from legacy procedures.

It will be appreciated that one or more of the operations shown in FIG. 5B may be omitted, replaced, re-ordered, thereby providing additional examples of the present disclosure. For example, a focus may be placed on the feature of the context resume procedure being delayed (e.g., in comparison to forwarding of UL data), and so only steps relating to this feature could form another embodiment. Of course, all other combinations of steps are considered herein.

In another embodiment of the present disclosure, which may also be described with reference to FIG. 5B and the steps thereof, a method/procedure may be as follows:
1. Uu: RRCConnectionResumeRequest
2. Uu: RRCConnectionResume
3. UE: SRBs and DRBs resumed, AS sec re-established and UE enters RRC_CONNECTED
4. Uu: RRCConnectionResumeComplete
5. Uu: UL data transmitted and stored at eNB
   The eNB may, for example, store and forward this data until reaching ground gateway
6. Uu: UE released.
   UE is released with RRC connection suspended.
7. UE released.
8. eNB: eNB is in touch with ground station.
9. S1: eNB sends MME UE Context Resume Request.
   The eNB may for instance indicate that the data is Store and Forward data. This can tell the core network that it may be unable to reach the UE at the current point.
10. Modify bearers.
11. S1: MME sends MME UE context Resume Response.
12. UL data delivered from MME to S-GW.

For downlink data, in accordance with various examples of the present disclosure, the procedures to resume the UE context are performed in advance (e.g., in comparison to legacy procedures). The DL data may also be sent in advance, to be stored by the eNB.

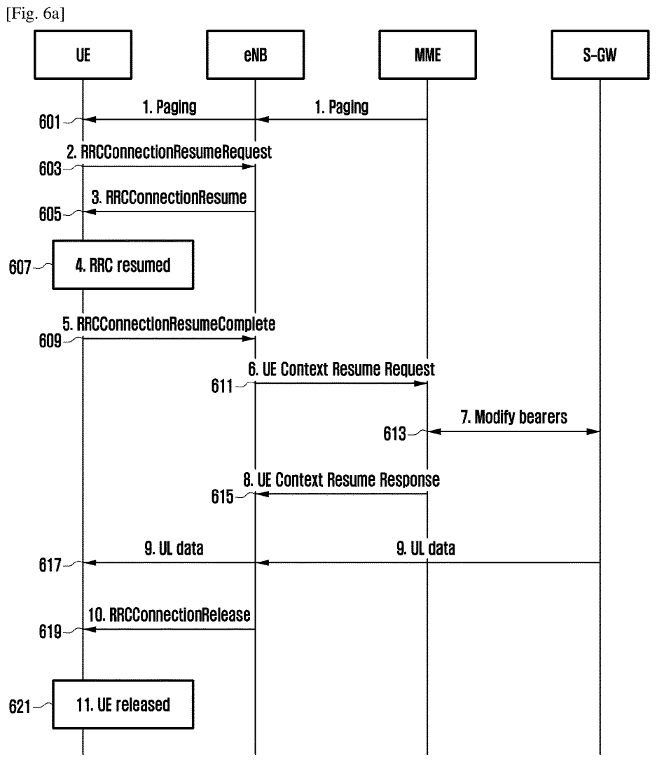

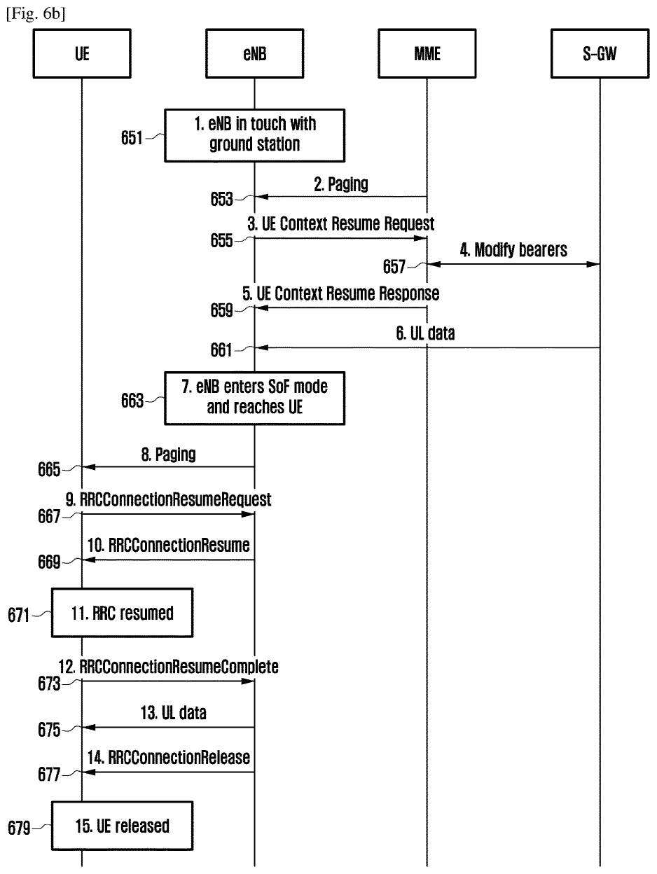

FIG. 6A shows a legacy resume procedure for delivering downlink data. In step 1 (601), an MME pages an eNB and the eNB pages a UE. In step 2 (603), the UE sends RRCConnectionResumeRequest to the eNB. In step 3 (605), the eNB sends RRCConnectionResume to the UE. In step 4 (607), RRC is resumed, e.g., the UE may resume SRBs and DRBs, AS sec (AS Security) may be re-established and the UE may enter RRC_CONNECTED. In step 5 (609), the UE may send RRCConnectionResumeComplete to the eNB. In step 6 (611), the eNB may transmit UE Context Resume Request message to the MME. In step 7 (613), the MME (and SGW) may modify bearers (e.g., for the UE). In step 8 (615), the MME may send UE Context Resume Response to the eNB. In step 9 (617), the SWG may send (e.g., forward, deliver etc.) downlink (DL) data to the eNB, and the eNB may send (e.g., forward, deliver etc.) the DL data to the UE. In step 10 (619), the eNB sends RRCConnectionRelease to the UE. In step 11 (621), UE release occurs.

FIG. 6A is provided to allow for comparison with embodiments of the present disclosure such as shown in FIG. 6B, which shows an example of DL data procedure in a Store and Forward network using RRC Resume.

Referring to FIG. 6B, in step 1 (651) an eNB may determine itself to be, or may be, in touch with a ground station.

In step 2 (653), a MME may page the eNB (e.g., over S1 interface).

In step 3 (655), the eNB may send a UE context Resume Request (e.g., in a message) to the MME (e.g., over S1 interface). For example, the eNB can indicate that the UE is not reachable and that data will be stored and forwarded once UE is reached. Optionally, it can also be indicated whether it is expected that the satellite/eNB is expected to be in contact with the UE.

In step 4 (657), the MME and SWG may modify bearers (e.g., based on the UE context Resume Request).

In step 5 (659), the MME may send UE Context Response (e.g., in a message) to the eNB.

In step 6 (661), the eNB may receive DL data from the SGW. For example, the data is stored in the eNB to be delivered once the UE is reached/reachable. In another example, a timer is configured for how long the DL data is stored in the eNB. Upon expiration of the timer, the DL data packet may be deleted or marked for deletion. This can be useful to ensure that a SoF entity's memory is not overloaded.

In step 7 (663), the eNB may enter SoF mode and reach the UE. For example, the eNB detects that it is out of touch (e.g., no connection, insufficiently strong connection, our of coverage with) the ground station, and so enters SoF mode (e.g., transfers to a satellite). Once in SoF mode, the eNB may then reach the UE (e.g., coverage of the eNB/satellite reaches the UE).

In step 8 (665), the eNB may page the UE (e.g., over Uu interface).

In step 9 (667), the UE may send (e.g., in a message) RRCConnectionResumeRequest to the eNB (e.g., over Uu interface).

In step 10 (669), the eNB may send (e.g., in a message) RRCConnectionResume to the UE (e.g., over Uu interface).

In step 11 (671), RRCResume at the UE occurs (e.g., in response to receiving RRConnectionResume). For example, the UE may resume SRBs and DRBs, AS sec (AS Security) may be re-established and UE may enter RRC_CONNECTED.

In step 12 (673), the UE may send (e.g., in a message) RRCConnectionResumeComplete to the eNB (e.g., over Uu interface).

In step 13 (675), the eNB may (e.g., in a message) send (e.g., forward, deliver etc.) the DL data to the UE (e.g., over Uu interface).

In step 14 (677), the eNB may send (e.g., in a message) RRCConnectionRelease to the UE (e.g., over Uu interface).

In step 15 (679), UE release occurs.

It will be appreciated that one or more of the operations shown in FIG. 6B may be omitted, replaced, re-ordered, thereby providing additional examples of the present disclosure. For example, a focus may be placed on the feature of the context resume procedure being performed in advance (e.g., in comparison to forwarding of DL data), and so only steps relating to this feature could form another embodiment. For example, in one embodiment, only step 3, 5, and 7 with one or more of steps 9 to 14 may be included, thereby highlighting the UE context resume procedure being performed before RRC Connection Resume (unlike in FIG. 6A). Of course, all other combinations of steps are considered herein.

In another embodiment of the present disclosure, which may also be described with reference to FIG. 6B and the steps thereof, a method/procedure may be as follows:
1. eNB is in touch with ground station
2. S1: eNB receives paging from the MME
3. S1: eNB sends to the MME “UE context Resume Request”
4. Modify bearer(s)
5. S1: The MME sends to the MME “UE Context Response” message
   The eNB can indicate that the UE is not reachable and that data will be stored and forwarded once UE is reached. This can also indicate whether it is expected that the satellite/eNB is expected to be in contact with the UE.
6. DL data to eNB from S-GW
   The data is stored in the eNB to be delivered once UE is reached.
   In embodiment a timer is configured how long the DL data is stored in the eNB
7. eNB enters SoF mode and reaches UE
8. Uu: eNB pages UE
9. Uu: RRCConnectionResumeRequest
10. Uu: RRCConnectionResume
11. UE: SRBs and DRBs resumed, AS sec re-established and UE enters RRC_CONNECTED
12. Uu: RRCConnectionResumeComplete
13. Uu: DL data transmitted
14. Uu: UE released through RRCConnectionRelease
15. UE released

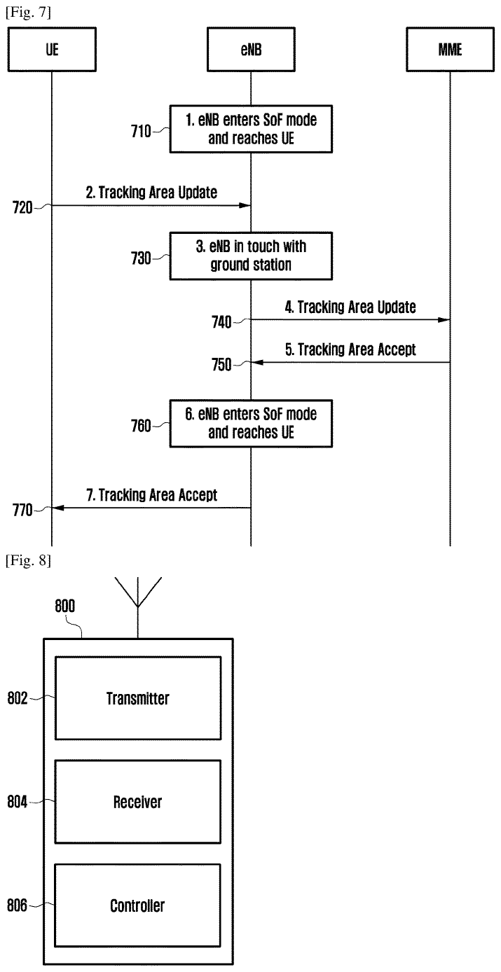

FIG. 7 shows an example of a resume procedure for tracking area updates in accordance with the present disclosure.

In step 1 (710), the eNB may enter SoF mode and reach the UE (e.g., coverage of the eNB reaches the UE).

In step 2 (720), the UE may send a tracking area update (e.g., NAS message) to the eNB (e.g., over Uu interface), which may be stored at the eNB. For example, this may include an indication that the UE is in a SoF mode.

In step 3 (730), the eNB may be in touch with a ground station. For example, the eNB may determine presence of a ground station, may connect to a ground station etc., after having been outside coverage of a/the ground station.

In step 4 (740), the eNB may send (e.g., forward) the tracking area update to an MME (e.g., over S1 interface).

In step 5 (750), the MME may transmit Tracking Area accept to the eNB, after receiving the tracking area update (e.g., in response to receiving the TA update). The Tracking Area accept may be stored in the eNB.

In step 6 (760), the eNB may enter SoF mode and reach the UE. For example, the eNB may move out of coverage or connection with the ground station, and so the eNB may transfer to a satellite, the coverage of which reaches the UE. In an example, the UE may be paged (by the eNB) regarding downlink data for the UE.

In step 7 (770), the eNB may send (e.g., forward) the Tracking Area accept to the UE.

It will be appreciated that one or more of the operations shown in FIG. 7 may be omitted, replaced, re-ordered, thereby providing additional examples of the present disclosure. For example, a focus may be placed on the steps relating to the eNB storing received data until the eNB is in touch with a ground station to forward the data to the MME (e.g., steps 2 to 4) and/or until the eNB enters SoF mode and reaches the UE to forward the data (e.g., steps 5 to 7). Of course, all other combinations of steps are considered herein.

In another embodiment of the present disclosure, which may also be described with reference to FIG. 7 and the steps thereof, a method/procedure may be as follows:
1. eNB enters SoF mode and reaches UE.
2. Uu: UE sends a Tracking Area update (NAS message) that is stored by eNB;
   e.g., this could include an indication that the UE is in a SoF mode.
3. eNB is in touch with a ground station.
4. S1: The Tracking Area update NAS message is forwarded to MME.
5. S1: After having received Tracking Area Update the MME replies with a Tracking Area Accept, which is stored by the eNB.
6. eNB enters SoF mode and reaches UE;
   e.g., the UE will be paged regarding downlink data for the UE.
7. Uu: eNB forwards the Tracking Area Accept to the UE.

FIG. 8 is a block diagram illustrating an exemplary network entity 800 (or electronic device, or network node etc.) that may be used in examples of the present disclosure. For example, a UE, eNB, device, network entity, network node, network function, network etc. as described in any of the embodiments/examples disclosed above may be implemented by or comprise network entity 800 (or be in combination with network entity 200). For example, an eNB, UE or MME in accordance with any of the examples/embodiments/aspects etc. described above may be implemented by or in combination with, or comprise, network entity 800.

The network entity 800 comprises a controller 805 (or at least one processor) and at least one of a transmitter 801, a receiver 803, or a transceiver (not shown). It will be appreciated that network entity may comprise an antenna also.

For example: controller 805 may be arranged to control the network entity 800 to perform any of the one or more features, operations or functions disclosed in relation to a network entity above; transmitter 801 may be arranged to transmit any one or more of the information, signals, data etc. mentioned above; and receiver 803 may be arranged to receive any one or more of the information, signals, data etc. mentioned above. The person skilled in the art would understand how such a network entity 800 in accordance with anyone or more example/embodiment disclosed herein may be provided.

For all of the examples/aspects/embodiments etc. described above/herein, it should be considered that the corresponding features/operations apply in any order or combination, and that furthermore there exists the possibility to omit one or more features/operations.

Moreover, for all of the examples, embodiments, aspects etc. above, these apply to at least LTE, NR, NR NTN or IoT NTN (note this list is merely to give some examples and should not be seen as limiting), including any related signalling/messages on any of the inferences X2, Xn, NG, S1, F1, etc (again, this list is merely to give some examples and should not be seen as limiting). It will be appreciated that, in each example/embodiment/aspect etc. described above, one or more features or operations may be omitted, modified or moved (e.g., to change the order of the features or the operations), if desired and appropriate.

Additionally, where the figures illustrating example method flows include text in relation to a specific step/operation, it will be appreciated that this text is simply an example of the corresponding step/operation, where a more general definition (such as may be found in the description of the corresponding step) may apply for the step/operation.

Additionally, regarding all of the above, one or more features or operations etc. from any example/embodiment may be combined with features or operations from any other example/embodiment. That is, the present disclosure should be considered to include all combinations of examples/embodiments disclosed herein, as appropriate, as well as combinations of individual features within and between each example/embodiment, as appropriate.

The techniques described herein may be implemented using any suitably configured apparatus and/or system. Such an apparatus and/or system may be configured to perform a method according to any aspect, embodiment or example disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment and/or aspect disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention.

The reader's attention is directed to all papers and documents which are filed concurrently with or previous to this specification in connection with this application and which are open to public inspection with this specification, and the contents of all such papers and documents are incorporated herein by reference.

Acronyms and Definitions

| | |
|---|---|
| 3GPP | 3^{rd} Generation Partnership Project |
| 5G | 5^{th} Generation |
| 5GC | 5G Core |
| 5QI | 5G QoS Identifier |
| 5GS | 5G System |
| 5GSM | 5G System Session Management |
| 5GMM | 5G System Mobility Management |
| AF | Application Function |
| AI | Artificial Intelligence |
| AM | Acknowledged Mode |
| AMF | Access and Mobility Management Function |
| AS | Application Server |
| ASP | Application Service Provider |
| AUSF | Authentication Server Function |
| CDN | Content Delivery Network |
| DCAF | Data Collection Application Function |
| DNAI | Data Network Access Identifier |
| DNN | Data Network Name |
| DNS | Domain Name Server |
| DRB | Data Radio Bearer |
| eNB | Evolved Node B |
| EPC | Evolved Packet Core |
| FEC | Forward Error Correction |
| FQDN | Fully Qualified Domain Name |
| GBR | Guaranteed Bit Rate |
| gNB | Next generation Node B |
| GPSI | Generic Public Subscription Identifier |
| HSS | Home Subscriber Service |
| IAB | Integrated Access and Backhaul |
| ID | Identity/Identifier |
| IIoT | Industrial Internet of Things |
| IMEI | International Mobile Equipment Identities |
| IP | Internet Protocol |
| I-SMF | Intermediate SMF |
| LADN | Local Area Data Network |
| LL SSM | Lower Layer SSM |
| MBMS | Multimedia Broadcast/Multicast Service |
| MBS | Multicast/Broadcast Service |
| MBSF | Multicast/Broadcast Service Function |
| MBSTF | Multicast/Broadcast Service Transport Function |
| MB-SMF | Multicast/Broadcast Session Management Function |
| MB-UPF | Multicast/Broadcast User Plane Function |
| ML | Machine Learning |
| MME | Mobility Management Entity |
| MN | Master Node |
| MNO | Mobile Network Operator |
| MT | Mobile Termination |
| NAS | Non-Access Stratum |
| NEF | Network Exposure Function |
| NRF | Network Repository Function |
| NG-RAN | Next Generation Radio Access Network |
| NG-eNB | Next Generation eNB |
| NSA | Non-Standalone |
| NSSF | Network Slice Selection Function |
| NTN | Non-Terrestrial Networks |
| NW | Network |
| NWDAF | Network Data Analytics Function |
| OS | Operating System |
| OSAPP | OS Application |
| PCF | Policy Control Function |
| PCO | Protocol Configuration Options |
| PDR | Packet Detection Rule |
| PDU | Protocol Data Unit |
| PTM | Point To Multipoint |
| PTP | Point to Point |
| QFI | QoS Flow Identifier (ID) |
| QoS | Quality of Service |
| RACH | Random Access Channel |
| RAN | Radio Access Network |
| RRC | Radio Resource Control |
| RSD | Route Selection Descriptor |
| SA | Standalone |
| SDAP | Service Data Adaptation Protocol |
| SDU | Service Data Unit |
| SGW | Serving Gateway |
| SIM | Subscriber Identity Module |
| SLA | Service Level Agreement |
| SM | Session Management |
| SMF | Session Management Function |
| SN | Secondary Node |
| S-NSSAI | Single Network Slice Selection Assistance Information |
| SSB | Synchronization Signal Block |
| SSM | Source Specific IP Multicast address |
| SSC | Session and Service Continuity |
| SRB | Signaling Radio Bearer |
| SUPI | Subscription Permanent Identifier |
| TA | Tracking Area |
| TAI | Tracking Area Identity |
| TE | Terminal Equipment |
| TM | Transparent Mode |
| TMGI | Temporary Mobile Group Identity |
| TS | Technical Specification |
| UDM | Unified Data Manager |
| UDR | Unified Data Repository |
| UE | User Equipment |
| UL | Uplink |
| UM | Unacknowledged Mode |
| UP | User Plane |
| UPF | User Plane Function |
| URLLC | Ultra-Reliable and Low-Latency Communication |
| URSP | UE Route Selection Policy |

1-15. (canceled)

16. A first entity in a wireless communication system, the first entity comprising:
a transceiver; and
at least one processor coupled with the transceiver and configured to:
identify whether a cell is operating in a store and forward (S&F) mode, and
in case that the cell is operating in the S&F mode, transmit, to a second entity, information on the S&F mode,
wherein the information on the S&F mode indicates that the cell is operating in the S&F mode, and
wherein the information on the S&F mode comprises a value indicating the cell is barred for the second entity supporting an S&F operation.

17. The first entity of claim 16, wherein the information on the S&F is transmitted to the second entity in a system information block (SIB) message.

18. The first entity of claim 16,
wherein the first entity comprises at least one of a base station or the cell, and
wherein the second entity comprises a terminal.

19. The first entity of claim 16,
wherein the information on the S&F further comprises at least one of information on a cell list or information on a list of procedures which are allowed or not allowed,
wherein at least one service is barred by the second entity,
wherein the first entity is deprioritized based on the information on the S&F, and
wherein the second entity is in an idle mode or inactive mode.

20. A second entity in a wireless communication system, the second entity comprising:
a transceiver; and
at least one processor coupled with the transceiver and configured to:
in case that a cell is operating in a store and forward (S&F) mode, receive, from a first entity, information on the S&F mode, and
based on the information on the S&F mode, identify whether the cell is barred,
wherein the information on the S&F mode indicates that the cell is operating in the S&F mode, and
wherein the information on the S&F mode comprises a value indicating the cell is barred for the second entity supporting an S&F operation.

21. The second entity of claim 20, wherein the information on the S&F is received from the first entity in a system information block (SIB) message.

22. The second entity of claim 20,
wherein the first entity comprises at least one of a base station or the cell, and
wherein the second entity comprises a terminal.

23. The second entity of claim 20,
wherein the information on the S&F further comprises at least one of information on a cell list or information on a list of procedures which are allowed or not allowed,
wherein at least one service is barred by the second entity,
wherein the first entity is deprioritized based on the information on the S&F, and
wherein the second entity is in an idle mode or inactive mode.

24. A method performed by a first entity in a wireless communication system, the method comprising:
identifying whether a cell is operating in a store and forward (S&F) mode; and
in case that the cell is operating in the S&F mode, transmitting, to a second entity, information on the S&F mode,
wherein the information on the S&F mode indicates that the cell is operating in the S&F mode, and
wherein the information on the S&F mode comprises a value indicating the cell is barred for the second entity supporting an S&F operation.

25. The method of claim 24,
wherein the information on the S&F is transmitted to the second entity in a system information block (SIB) message.

26. The method of claim 24,
wherein the first entity comprises at least one of a base station or the cell, and
wherein the second entity comprises a terminal.

27. The method of claim 24,
wherein the information on the S&F further comprises at least one of information on a cell list or information on a list of procedures which are allowed or not allowed,
wherein at least one service is barred by the second entity,
wherein the first entity is deprioritized based on the information on the S&F, and
wherein the second entity is in an idle mode or inactive mode.

28. A method performed by a second entity in a wireless communication system, the method comprising:
in case that a cell is operating in a store and forward (S&F) mode, receiving, from a first entity, information on the S&F mode; and
based on the information on the S&F mode, identifying whether the cell is barred,
wherein the information on the S&F mode indicates that the cell is operating in the S&F mode, and
wherein the information on the S&F mode comprises a value indicating the cell is barred for the second entity supporting an S&F operation.

29. The method of claim 28,
wherein the information on the S&F is received from the first entity in a system information block (SIB) message,
wherein the first entity comprises at least one of a base station or the cell, and
wherein the second entity comprises a terminal.

30. The method of claim 28,
wherein the information on the S&F further comprises at least one of information on a cell list or information on a list of procedures which are allowed or not allowed,
wherein at least one service is barred by the second entity,
wherein the first entity is deprioritized based on the information on the S&F, and
wherein the second entity is in an idle mode or inactive mode.
